(19) United States
(12) Patent Application Publication
(10) Pub. No.: US 2018/0129871 A1
(43) Pub. Date: May 10, 2018

(54) BEHAVIOR PATTERN STATISTICAL APPARATUS AND METHOD

(71) Applicant: AINEMO INC, Beijing (CN)

(72) Inventor: Chenfeng SONG, Las Vegas, NV (US)

(21) Appl. No.: 15/321,324

(22) PCT Filed: Sep. 15, 2014
(86) PCT No.: PCT/CN2014/086572

§ 371 Date: Nov. 6, 2017

(30) Foreign Application Priority Data
Jun. 26, 2014 (CN) 201410301533.3

(51) Int. Cl. G06K 9/00; H04N 5/247; H04N 7/18; G06F 17/30

(52) U.S. Cl. CPC G06K 9/00335; H04N 13/025; H04N 5/247; G06F 17/30044; G06F 17/3005; G06F 17/30029; H04N 7/18

(57) ABSTRACT

The present invention discloses a behavior pattern statistical apparatus and method. The behavior pattern statistical apparatus comprises: a video capture unit, used for real-time capture and transmission of video information; an audio capture unit, used for real-time capture and transmission of audio information: a processing device, used for identifying a specific person or specific action from video and audio information captured by the video capture unit and the audio capture unit, and for responding to the attribute values identifying the specific person's specific action identified in the captured video and audio information; a storage device, used for storing the attribute values in association with the specific person, the specific action of the specific person, and the specific action identified by a processing device; an output interface, used for outputting the statistical attribute values of the specific action of the specific person at a specific time. The present invention can analyze the behavior patterns of members of a household, satisfying the requirements of a smart home.

This application claims the benefit of a Chinese patent application No. 201410301533.3 filed on Jun. 26, 2014, with the title “BEHAVIOR PATTERN STATISTICAL APPARATUS AND METHOD”; the entire contents of which are incorporated herein by reference.

### TECHNICAL FIELD

The present invention relates to a household smart device, and more specifically to a behavior pattern statistical apparatus and method.

### BACKGROUND

There is such a need in the field of household smart devices to conduct statistics on the behavior patterns of family members in order to evaluate and analyze the existing types of behavior patterns. Then find out where it needs to be corrected, and so on. However, the current level of development in the field of household smart devices can not meet this requirement.

### SUMMARY

One of the technical problems to be solved by the present invention is to provide a technique for analyzing behavior patterns of family members in order to meet the needs of household smart devices.

According to an embodiment of an aspect of the present invention, there is provided a behavior pattern statistical apparatus comprises: a video capture unit, an audio capture unit, a processing device, a storage and an output interface. The video capture unit is used for collecting and transmitting video information in real time. The audio capture unit is used for collecting and transmitting audio information in real time. The processing device is used for identifying a specific person's specific action from the video and audio information collected by the video capture unit and the audio capture unit, and identifying an attribute value of the specific action in the collected video and audio information in response to identifying a specific action of a specific person. The storage is used for storing a specific person recognized by the processing device, a specific action of the specific person, and an attribute value of the specific action in combination. The output interface is used for outputting statistical attribute values of a specific action of a specific person for a certain period of time, wherein a statistical attribute value of a specific action of a specific person over a specific period of time is a statistic of the processing device for all of the specific actions of the specific person over a specific time period.

According to an embodiment of the present invention, the behavior pattern statistical apparatus is further comprising: an input interface for receiving a user's detailed query indication of a specific action of a specific person for a specific time period. In response to the user's detailed query indication, the output interface displays all the specific actions of a specific person for a specific period of time, including a specific person, a specific action of the specific person, and an attribute value of the specific action.

According to an embodiment of the present invention, the behavior pattern statistical apparatus is further comprising: a recorder for initiating recording of the video and audio information captured by the video capture unit and the audio capture unit in response to identifying a specific action of a specific person and stops recording in response to recognizing that a specific person's specific action is ended, and stores the recorded content in a storage the identified specific person, the specific action of the specific person and the attribute value of the specific action in combination. In response to the user's detailed query indication, the output interface further displays the visual and audio links of the specific action in combination with the specific person, the specific action of the specific person, and the attribute value of the specific action.

According to an embodiment of the present invention, in response to the user clicking a link for a video or an audio, the output interface outputs recorded content stored in the storage related to the specific person, the specific action of the specific person, and the attribute value of the specific action.

According to an embodiment of the present invention, the processing device also compares the statistical attribute values of a specific action of a specific person for a certain period of time with respective thresholds, generates an evaluation based on the comparison result, and then output through the output interface.

According to an embodiment of the present invention, the processing device further compares the statistical attribute value of the specific action of the specific person with the statistical attribute value of the specific action of the other person at the specific time period, and output through the output interface by paralleling. The processing device further compares the statistical attribute value of the specific action of the specific person with the statistical attribute value of the specific action of the specific person at other previous time periods, and output through the output interface by paralleling. The output interface is at least one of the group of a display, a speaker, a wireless transmitter to send a short message, a WeChat application interface module to send a WeChat, an email application interface module to send an email, and an interface modules that send application-specific messages. The behavior pattern statistical apparatus further comprising: an input interface for receiving at least one of a specified action of a specific person to be identified, a corresponding attribute, and a name of a corresponding statistical attribute.

According to an embodiment of the present invention, the processing device identifies a specific action of a specific person from the video and audio information collected by the video capture unit and the audio capture unit.

According to an embodiment of the present invention, the specific person is identified based on one or more of face recognition, height recognition and voice recognition.

According to an embodiment of the present invention, the processing device further receives a wireless signal sent by a mobile phone and identifies a specific person based on the identity of the mobile phone indicated in the wireless signal.

According to an embodiment of the present invention, the specific action is identified by previously setting a model for a specific action, and searching the video and audio information collected respectively from the video capture unit and the audio capture unit for an action matching the model.

According to an embodiment of the present invention, the model is generated by means of self-learning.

According to an embodiment of the present invention, the model is a previously-input standardized model.

According to an embodiment of the present invention, the behavior pattern statistical apparatus is further comprising a depth sensor, and the identification of the specific action is based on the video and audio captured respectively by the video capture unit and the audio capture unit, and the depth sensed by the depth sensor.

According to an embodiment of the present invention, the behavior pattern statistical apparatus is further comprising: a rotation means for rotating the video capture unit. Preferably, in response to identifying a specific person-specific action from the video and audio respectively captured by the video capture unit and the audio capture unit, the rotating device rotates the video capture unit in a direction facing the identified element.

According to an embodiment of the present invention, the behavior pattern statistical apparatus is further comprising: a light sensor for sensing ambient light changes in the behavior pattern statistical apparatus, wherein the display brightness of the display is adjusted according to the sensed change of the light.

According to an embodiment of an aspect of the present invention, there is provided a behavioral pattern statistical method comprising: capturing video and audio information in real-time; recognizing a specific action of a specific person from the video and audio information; identifying an attribute value of the specific action in the collected video and audio information, in response to recognizing a specific action of a specific person; obtaining statistics of attribute values of all the specific actions of the specific person in a specific time period to obtain statistical attribute values of a specific action of a specific person in a specific time period; outputting the attribute value or statistical attribute value of a specific action of a specific person for a certain period of time.

According to an embodiment of the present invention, after recognizing a specific action of a specific person, storing the identified specific person, the specific action of the specific person, and the attribute value of the specific action in combination.

According to an embodiment of the present invention, the behavior pattern statistics method further comprising: receiving a user's detailed query indication of a specific action of a specific person for a specific period of time; in response to the user's detailed query indication, displaying, all of the specific actions of a specific person for a certain period of time, including a specific person, a specific action of the specific person, and an attribute value of the specific action.

According to an embodiment of the present invention, the behavior pattern statistics method is further comprising: in response to identifying a specific person's specific action, recording the captured video and audio information and in response to recognizing that a specific person's specific action has ended, stopping the recording and storing the recorded content in combination with the identified specific person, the specific person's specific action, and attribute values of the specific action; in response to the user's detailed query indication, the visual or audio links for the specific action are displayed in combination with the specific person, the specific person's specific action, and attribute values of the specific action.

According to an embodiment of the present invention, in response to the user clicking the visual or audio links, the output interface outputs the recorded content which is stored in combination with the specific person, the specific person's specific action, and attribute values of the specific action.

According to an embodiment of the present invention, the behavior pattern statistical method is further comprising comparing a statistical attribute value of a specific action of a specific person for a certain period of time with a corresponding threshold, generating a rating based on the comparison result, and outputting the result.

According to an embodiment of the present invention, the behavior pattern statistical method further comprising: outputting the statistical attribute value of the specific action of the specific person for a certain period of time against the statistical attribute value of the specific action of other people at the specific time period.

According to an embodiment of the present invention, the behavior pattern statistical method is further comprising: outputting the statistical attribute value of the specific action of the specific person at a certain time period in comparison with the statistical attribute value of the specific action of the specific person at other previous time periods.

According to an embodiment of the present invention, the attribute value or the statistical attribute value is output by at least one of the group of a display, a speaker, a wireless transmitter to send a short message, a WeChat application interface module to send a WeChat, an email application interface module to send an email, and an interface modules that send application-specific messages.

According to an embodiment of the present invention, the behavior pattern statistical method is further comprising: receiving at least one of a specified action of specific person to be identified, a corresponding attribute, a name of a corresponding statistical attribute.

According to an embodiment of the present invention, the specific person is identified by basing on one or more of face recognition, height recognition, and voice recognition.

According to an embodiment of the present invention, the method is further comprising receiving a wireless signal transmitted by a handset that is identified based of the identity of the hand-held mobile phone indicated in the wireless signal.

According to an embodiment of the present invention, the specific action is identified by creating a model for a specific action in advance and searching the acquired video and audio information for a match identified with the established model.

According to an embodiment of the present invention, the model is generated by means of self-learning.

According to an embodiment of the present invention, the specific action is identified based on the collected video and audio and the depth sensed by the depth sensor.

Since one embodiment of the present invention enables the captured video and audio content to be identified, the specific action of a specific person and their associated attribute values are identified. The attribute values are used for recording and statistics. These attribute values reflect the behavior of each person's specific action patterns. Therefore, it achieves the beneficial effect of analyzing the behavior patterns of family members to meet the needs of household smart devices.

Those of ordinary skill in the art will understand that although the following detailed description will be made with reference to the illustrated embodiments and the accompanying drawings, the present invention is not limited to these embodiments. Rather, the scope of the invention is to be broadly extended, and is intended to define the scope of the invention only by the appended claims.

### BRIEF DESCRIPTION OF THE DRAWINGS

Other features, objects, and advantages of the present invention will become apparent by reading the following detailed description of the non-limiting embodiments regarding the following drawings:

FIG. 1 shows a schematic block diagram of a behavior pattern statistical apparatus according to one embodiment of the present invention;

FIG. 2 shows an external front view of a behavior pattern counting device according to one embodiment of the present invention;

FIG. 3 shows an external left side view of a behavior pattern counting device according to one embodiment of the present invention;

FIG. 4a shows an attribute value record table stored in the storage of the behavior pattern counting device according to one embodiment of the present invention for the whole family watching TV in the first week of June;

FIG. 4b shows an attribute value record table stored in a storage of a behavior pattern statistical apparatus according to an embodiment of the present invention for sleeping status of a whole family;

FIG. 5a shows a statistics table of attribute values of Tom watching TV in the first week of June output by an output interface of a behavior pattern statistical apparatus according to an embodiment of the present invention;

FIG. 5b shows the content output by the output interface when the user selects “View Details” in FIG. 5a;

FIG. 6 shows the statistics attribute value and evaluation of Tom watching TV in the first week of June output by the output interface of the behavior pattern statistical apparatus according to an embodiment of the present invention;

FIG. 7a shows a statistics table of attribute values of the whole family watching television in the first week of June according to an output interface of a behavior pattern statistical apparatus according to an embodiment of the present invention;

FIG. 7b shows a statistic attribute value comparison table of Tom watching TV in the first week of June and the last week of May output by the output interface of the behavior pattern statistical apparatus according to an embodiment of the present invention;

FIG. 8 shows a flowchart of a behavior pattern statistical method according to a further embodiment of the present invention;

FIG. 9 shows yet another flow chart of a behavior pattern statistical method according to yet another embodiment of the present invention.

The same or similar reference numbers in the drawings represent the same or similar components.

### DETAILED DESCRIPTION

The invention will now be described in further detail with reference to the accompanying drawings.

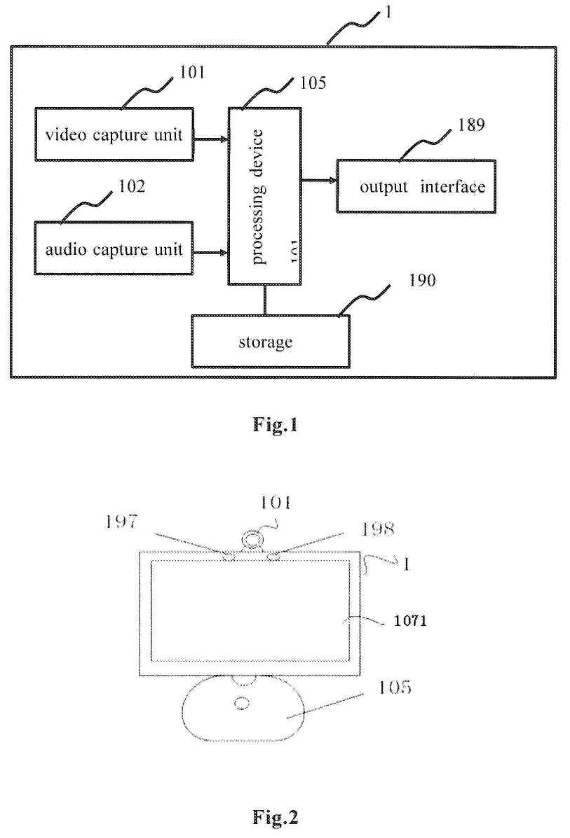

FIG. 1 shows a schematic block diagram of a behavior pattern statistical apparatus according to one embodiment of the present invention. The behavior pattern statistical apparatus 1 according to one embodiment of the present invention includes a video capture unit 101, an audio capture unit 102, a processing device 105, an output interface 189, and a storage 190. The video capture unit 101 and the audio capture unit 102 respectively collect video and audio in real time and send the video and audio to the processing device 105. The processing device 105 identifies the contents of the video and audio information in response to the received video and audio information, tracks and analyzes the specific actions of the identified specific persons to obtain the attribute values of the specific actions. The output interface 189 is connected to the processing device 105 for outputting statistical attribute values of a specific action of a specific person for a certain period of time. The storage 190 is a data storage device embedded in or attached to the processing device 105 and configured to store the specific actions of the specific person, the specific person, and the specific action recognized by the processing device 105 in combination.

Video capture unit refers to the device used for video capture, such as cameras, camera phones and so on. Audio capture unit refers to the device used for audio capture, such as microphones, tape recorders, mobile phones with sound recording capabilities. The processing device refers to a device that has data processing and analysis functions and is used to receive the video and audio information sent by the video capture unit and the audio capture unit, and processes the video and audio information to identify and issue corresponding instruction information. For example, it can be a CPU chip, a computer or multiple computers processing center. The output interface 189 may be one or more of the display 1071, a speaker, a wireless transmitter to send a short message, a WeChat application interface module to send a WeChat, an email application interface module to send an email, an interface module to send a specific application specific message. The storage 190 may be a computer storage, a removable hard disk, a USB flash drive, a storage card, or the like that can function as a data storage device. The multiple types of the output interface 189 improve the diversity and flexibility of the information output channels, and enhance the user experience.

FIG. 2 shows an external front view of a behavior pattern counting device according to one embodiment of the invention. In this embodiment, the video capture unit 101 is a camera located at the upper end of the display 1071. The treatment device 105 is enclosed in the base.

During operation, the video capture unit 101 and the audio capture unit 102 send the video and audio information collected by the video capture unit 101 to the processing device 105. The processing device 105 identifies the received video and audio information, identifying the specific action of a specific person, and tracks the specific actions of the identified specific people; gets the value of a specific action for that specific person. The identified specific person, the specific action of the specific person, and the attribute value of the specific action are stored in the storage 190 in combination. The processing device 105 counts the attribute values of all the specific actions of the specific person for a specific period of time based on the data recorded in the storage 190. Thus, the statistical attribute value of a specific action of a specific person at a specific time period is obtained; The attribute value or the statistic attribute value of the specific action of the specific person in the specific time period are output through the output interface 189.

The attribute refers to some characteristics in the action. These characteristics can be seen from the characteristics of human behavior model. For example, for watching TV, attributes such as start time, end time, duration, number of breaks, etc. Some people watch TV for a long time, while others watch TV late at night. Therefore, these attributes reflect their behavioral characteristics. Attribute value is the value of a attribute. For example, 23:00 start watching TV, attribute value is 23:00. The attribute value is an objective record of a specific person's specific action captured by the video capture unit and the audio capture unit and recognized by the processing device. Results data that can be obtained without any mathematical statistics on recorded data. The statistical attribute value is a statistical result data obtained after performing mathematical statistics based on the recorded attribute values, for example, the number of times that a specific person has a specific action in a specific time period, the average duration of a specific action of a specific person in a specific time period, the total time of a specific action of a specific person in a specific time period, and the like.

After statistically obtaining the statistical attribute values for a specific action of a specific person for a specific period of time, the processing device generates an assessment of that specific action based on the comparison result by comparison with the corresponding threshold. The threshold value and its corresponding prompt evaluation are stored in advance in the storage. For example, when it is detected that children watch television for more than 2 hours, an evaluation is given that “Time for watching TV is too long, please have rest.” Here, the threshold is “2 hours.” The threshold of “2 hours” and the prompt evaluation of “Time for watching TV is too long, please have rest” is stored in advance in storage.

In addition, the attribute value or the statistical attribute value may be output through a table or other manners that can be implemented by those skilled in the art.

The behavior pattern statistical apparatus 1 can identify one or more of the identities indicated by the wireless signals transmitted by the mobile phone based on face recognition, height recognition and voice recognition through the video capture unit 101, the audio capture unit 102 and other devices or units to identify specific people. A variety of ways to identify people compared to the combination of only a single way to identify, increasing the recognition of people's accuracy.

In the case of identifying a specific person, the pattern and/or height and/or sound frequency of a specific person's face may be stored in the storage in advance. When a certain area in the captured image matches the stored pattern of the specific face; and/or when the distance between the specific face and the behavior pattern statistical apparatus 1 sensed by the position sensor; and/or when the depth sensor is determined that its height matches the stored height; and/or when the audio captured by the audio capture unit 102 matches the stored frequency of the specific human voice, the existence of a specific person can be identified.

Identifying people or the existence of a specific person can also be self-learning. For example, if a pattern in a captured image always appears at a certain frequency with the captured sound, a prompt can be displayed on the display. That is, a person has been identified, the user of the behavior pattern statistical apparatus 1 is invited to judge and name the identified person. If the user of the behavior pattern statistical apparatus 1 finds out that it is a recognition error, it is fed back on the display interface. Upon receipt of such feedback, no human or specific person is deemed present at the same time as this pattern in the next shot of the image appears coincident with such frequency of captured sound. In the self-learning mode, the pattern and/or height and/or sound frequency of the face of a specific person may also not be stored in advance in storage.

In addition, it is also possible to identify a person or a specific person on the basis of a wireless signal transmitted from a portable phone. For example, the behavior pattern statistical apparatus 1 is a Bluetooth device, and the trusted user's cell phone also has a Bluetooth wireless unit. When the behavior pattern statistical apparatus 1 recognizes that the Bluetooth wireless unit of a specific identity appears within a certain distance, it is considered that a specific person is identified.

The specific action is to create a model for a specific action in advance and search for the matching identification with the established model from the video and audio information respectively collected by the video capture unit 101 and the audio capture unit 102.

Optionally, the model is a standardized model that is input in advance, that is, artificially set in advance and a model is established according to a set action. For example, for an action like watching TV, create a model that identifies a person sitting on a couch, looks down the person's gaze, has an object, recognizes that the object is a television, and the person stays on television at least 10 seconds. If a person is detected from the image captured by the video capture unit 101 and then the person is detected to be sitting on the couch (the recognition of the sofa resembles face recognition can also be performed by pattern matching or the image of the person sitting on the sofa as a whole as an object for pattern matching recognition), and then detect the direction of the person's gaze, and then detect whether the object in the gaze direction of the person is a television (for example, the television is modeled as an object), and if so counts for 10 seconds.

Of course, the behavior pattern statistical apparatus 1 may also automatically create an action model by means of self-learning such as machine learning. For example, the behavior pattern statistical apparatus 1 extracts the action feature from the video and audio captured by the video capture unit 101, the audio capture unit 102, and establishes the action model based on the extracted feature. For example, one person found in the video and audio captured by the video capture unit 101 and the audio capture unit 102 finds himself sitting on the couch, having a television in the direction of the person's eyes and watching the event of the person staying on the television If the frequency exceeds the threshold for more than 10 seconds, this is considered as a model of a specific action. In this case, the motion model may not be stored in the database in advance, but a model of action is extracted from the video and audio captured from the video capture unit 101, the audio capture unit 102 in a self-learned manner.

In order to identify a specific action more accurately, the behavior pattern counting device 1 further includes a depth sensor 197. A specific action is jointly identified by the video capture unit 101, the audio capture unit 102, and the depth sensor through the captured video and audio as well as the sensed depth. Although the depth sensor 197 is located to the left of the upper border of the display in FIG. 2, it may be disposed at other reasonable positions.

The depth sensor 197 senses the distance between the person or the object and the behavior pattern counting device 1. When an action takes place on a person or an object, the magnitude of the change in the captured image will be different for the same range of motion due to the difference in distance from the behavior pattern counting device 1. Therefore, combined with the depth sensor, the movement can be more accurately identified, so as to improve the recognition accuracy.

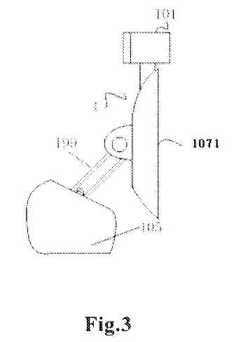

FIG. 3 shows an external left side view of the behavior pattern counting device according to one embodiment of the present invention. As shown in FIG. 3, in order to collect information better, the behavior pattern statistical apparatus 1 may further include a rotating device 199 for rotating the video capture unit 101. Preferably, in response to identifying one of the following elements from the video and audio respectively captured by the video capture unit 101 and the audio capture unit 102, the rotating device 199 rotates the video capture unit 101 in a direction facing the recognized element: specific person; or specific action.

In one embodiment, the video capture unit 101 shown in FIG. 3 may rotate left and right toward the identified element. In another embodiment, the video capture unit 101 shown in FIG. 3 can rotate up, down, left and right toward the identified elements.

Also referring to FIG. 2, as shown in FIG. 2, the behavior pattern statistical apparatus 1 may further include a light sensor 198 for sensing a change of ambient light around the behavior pattern statistical apparatus 1. The display brightness of the display 1071 is adjusted according to the change of the light. If the surrounding light is stronger, it may increase the display brightness. If the surrounding light is weaken, it may reduce the display brightness. In this way, the discomfort of the eye viewing display can be reduced.

Although the light sensor in FIG. 2 is located at the right-hand side of the upper bezel of the display, it may be provided at any other reasonable location.

In one aspect of the invention, the output may be presented in tabular form. The table is composed of straight lines crossing the composition. Formally, the table consists of top headers, side headers, and statistics data. Among them, the top header is usually used to indicate the name of the project, indicators and so on placed in the upper row of the form. Side headers are often used, to indicate names of persons, actions, etc., generally placed on the left side of the form. The statistics data are the specific values for each item or attribute, at the intersection of each top header and side header. However, the table may have other layouts. For example, the side header is used to indicate the name of the item, index, etc. The top header is used to indicate the name of the person, the action, and the like. The form of the table is not limited.

In addition, the behavior pattern statistical apparatus 1 in this embodiment of the present invention may further include an input interface, configured to receive a detailed query indication of a specific action performed by a user on a specific person in a specific period of time. The input interface is, for example, a keyboard, a mouse, a touch screen and the like. In response to the user's detailed query indication, the output interface displays all the specific actions of a specific person for a specific period of time, including a specific person, a specific action of the specific person, and an attribute value of the specific action.

In addition, the behavior pattern statistical apparatus 1 according to an embodiment of the present invention may further include a recorder (not shown) for starting recording video and audio by the video capture unit 101 and the audio capture unit 102 in response to recognizing a specific action of a specific person, and then, stop recording in response to recognizing that the specific action of the specific person is ended, and then stores the recorded content in the storage 190 in association with the identified specific person, the specific person's specific action, and the attribute value of the specific action. In response to the user's detailed query indication, the output interface also displays the video and audio links for that specific action in conjunction with the specific person, the specific action of the specific person, and the attribute value of the specific action. In response to the user clicking the video and audio links, the recorded content stored in the interface output storage 190 in association with the specific person, the specific person's specific action, and the specific action's attribute value is output.

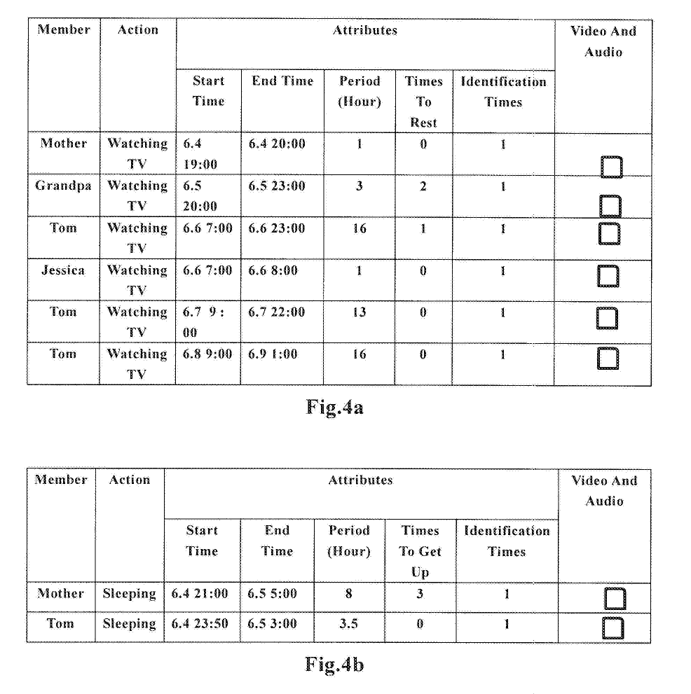

FIG. 4 shows a specific person, a specific action, an attribute value stored in combination in a storage of a behavior pattern statistical apparatus according to one embodiment of the present invention. Specifically, FIG. 4a shows an attribute value record table stored in the storage of the behavior pattern counting device according to one embodiment of the present invention regarding the whole family watching television in the first week of June. FIG. 4b shows an attribute value record table stored in the storage of the behavior pattern counting device according to one embodiment of the present invention on the family member's sleeping status on June 4.

The title of the top header items from left to right is member, action, attribute, video and audio in turn. The following attributes are divided into several specific attribute items, i.e. start time, end time, duration, rest times, identification times. Side headers from top to bottom, followed by mother watching TV, Grandpa watching TV, Tom watching TV, Jessica watching TV, Tom watching TV, Tom watching TV, which are specific persons and their action information. When the action occurs, then record a row more. For example, Tom watches television, happened several times. By the attribute value record table, you can visually see the start and end time, the duration of the specific action of the family member, the number of times the action appears. For example, my mother watched a television at 19:00 on June 4 for an hour and ended at 20:00 without a break in the middle. The last column of each horizontal line is the video and audio recorded for the specific action identified for that specific person for that line. The above table is only one example of the storage related content, and the storage format regarding the related content is not limited to the above example.

Although in the example of FIG. 4, the recorded video and audio are stored in the storage, the above video and audio may not be stored.

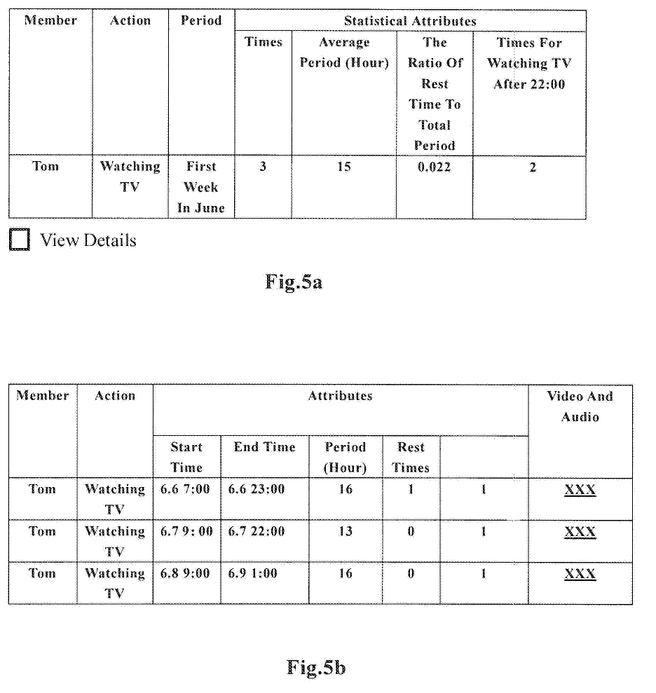

FIG. 5a shows the statistical attribute value result of a specific action of a specific person for a specific period of time output by the output interface of the behavior pattern statistical apparatus according to an embodiment of the present invention. Specifically, the result is a Tom watching TV statistics attribute value for the first week of June. It is based on Tom's record in FIG. 4a. For example, as you can see in FIG. 4a, Tom watched television for 3 times in the first week of June as a result of the cumulative “attribute count” attribute value of FIG. 4a for the 3 records of Tom watching TV in June. Average duration per time=(16+13+16)/3=15 (hours). Tom rests for 1 hour in a total of 45 hours. Therefore, the ratio of rest time to total period=1/45=0.022. The top header items from left to right are member, action, period, and statistical attributes. The following statistical attributes which are divided into several specific statistical attributes, including the number of times, the average period, the number of hours to rest, the number of times for watching television after 22:00. The side header states that the statistical object is Tom; the action is watching TV; the period is the first week in June. This output interface is for example a display.

The bottom of the table in FIG. 5a has a check box “View Details.” When the user sees the check box displayed on the display, for example, wants to check the details, the user selects the check box. The display then shows the graph of FIG. 5b, which is a summary of all TV watching action for Tom stored in FIG. 4 for the first week of June. The last column of each line also shows a link to the video and audio recorded by the recorder corresponding to the line of television watching. When the user clicks the link of the video and audio, the video and audio recorded by the recorder corresponding to the TV watching will be played by the output interface.

Although the “view details” check box is shown in FIG. 5a, this check box may not be set. Instead, it can take other ways that users can enter instructions for view details. In addition, it may not allow the user enter instructions for view details. In addition, the table of FIG. 5b may not contain the recorded video and audio links. At this moment, video and audio can not be played, but the statistics function still exists.

By storing the recorded video and audio in correspondence with the specific action of a specific person, it is possible to achieve the advantageous effect of allowing the user to later playback the video and audio and find out the reasons why the statistical result is not good.

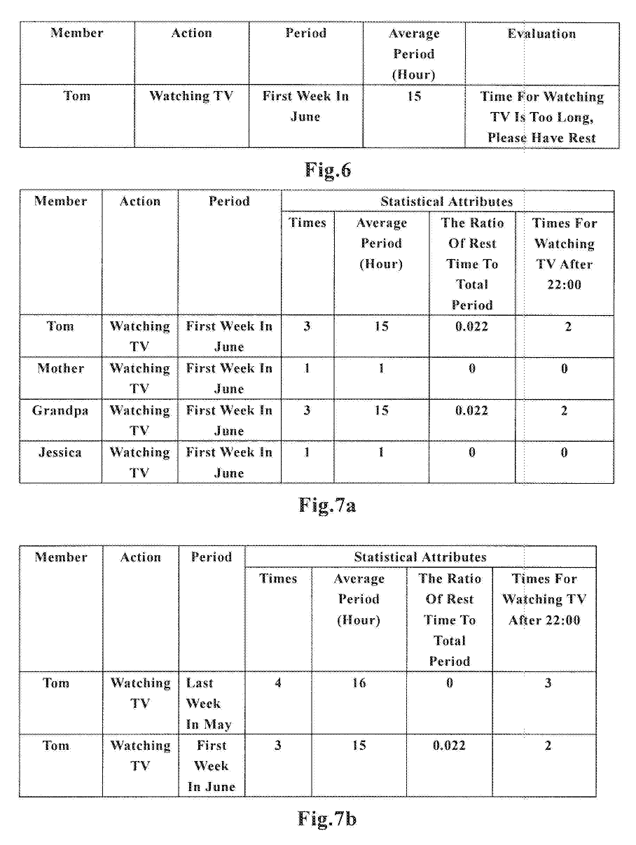

FIG. 6 shows statistical attribute values and evaluation of a specific person-specific action of a specific period of time output by an output interface of a behavior pattern statistical apparatus according to an embodiment of the present invention. Specifically, it is the statistical attribute value and evaluation of Tom watching TV in the first week of June. For example, the threshold=3 for the average duration of watching TV. Tom's average duration of watching TV in the first week of June=15, which much higher than 3. It searches a prompt evaluation stored in the database corresponding to the average duration of watching television more than 3, i.e., “Time for watching TV is too long, please have rest.” The evaluation is output together with the attribute values, as shown in FIG. 6. The top header of the form is from left to right in sequence of a member, an action, a period, an average duration, and an evaluation. The top row states that the statistics object is Tom, the action is watching TV, period is the first week of June.

The benefit of generating and outputting an evaluation over the prior art is that the user can see an automated prompt evaluation for his behavior. Which can guide their own behavior based on the content of the evaluation, so as to form good habits. If users only know the value of their own behavior, may still not know such an attribute value is good or bad, whether it needs improvement.

FIG. 7a shows a table output by an output interface of a behavior pattern statistical apparatus according to an embodiment of the present invention, which shows an attribute value of a specific action of a specific person in a specific period of time in comparison with an attribute value of a specific action of another person in the same specific period of time. Specifically, it is the statistical attribute value list of the whole family member watching television in the first week of June.

A statistical attribute value of a specific action of a specific person at a specific time period in compared with a statistical attribute value of a specific action of another person at a specific time period is output by the output interface 189. The advantage over the prior art is that the user can see the comparison or rankings of the attribute value of his action with that of other people, so as to determine their own attribute value is good or bad. It provides an objective basis for whether improvements need to be made.

FIG. 7b shows a table output by an output interface of a behavior pattern statistical apparatus according to an embodiment of the present invention, which shows an attribute value of a specific action of a specific person in a specific period of time in comparison with an attribute value of a specific action of the same person in the other previous specific period of time. Specifically, it is a statistical chart of statistical attributes of Tom watching TV in the first week of June and the last week of May.

One benefit of comparing the statistical attribute values for a specific action of a specific person over a specific time period to the statistical attribute values for a specific action of the same specific person at other previous time periods over the output interface 189 is that the user is enabled to see its changes in the value of the action attribute in different time periods to decide whether to improve their own behavior, enhance the user experience.

By comparing a specific action of different people in a specific time period or a specific action of a specific person in different time periods, it is possible to know the behavior change of a specific person in different time periods and the difference of behavior of a different person at a specific time.

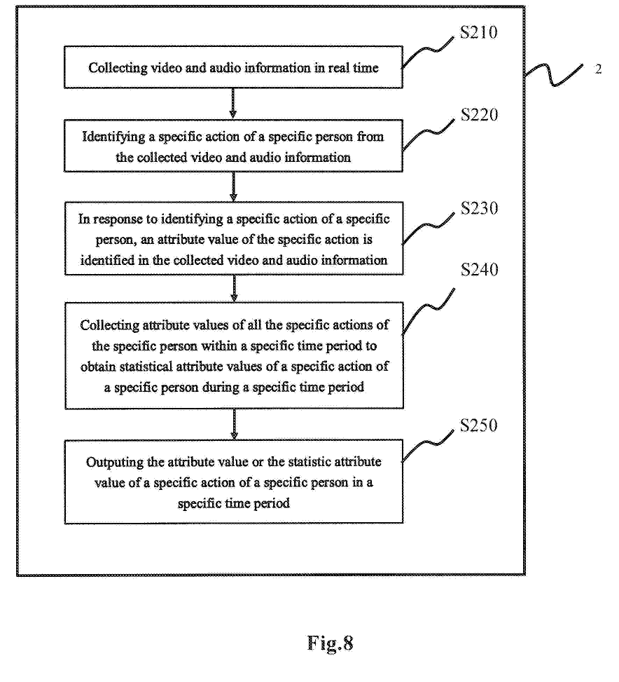

FIG. 8 shows a flowchart of a behavior pattern statistical method according to a further embodiment of the present invention. Behavior pattern statistics method 2 includes:

Step S210: Collecting video and audio information in real time.

Step S220: Identifying a specific action of a specific person from the collected video and audio information.

Step S230, in response to identifying a specific action of a specific person, an attribute value of the specific action is identified in the collected video and audio information.

Step S240: Collecting attribute values of all the specific actions of the specific person within a specific time period to obtain statistical attribute values of a specific action of a specific person during a specific time period.

Step S250: Outputting the attribute value or the statistic attribute value of a specific action of a specific person in a specific time period.

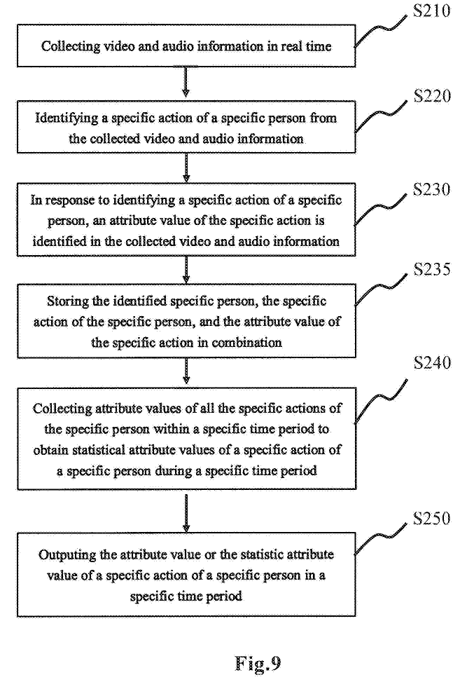

In addition, FIG. 9 shows still another flowchart of a behavior pattern statistical method according to still another embodiment of the present invention. On the basis of the contents shown in FIG. 8, a step S235 is added between step S230 and step S240 to store the identified specific person, the specific action of the specific person, and the attribute value of the specific action in combination.

In addition, the method may further include: receiving a user's detailed query indication of a specific action of a specific person for a specific period of time, and displaying all the specific actions of the specific person for a specific time period, including the specific person, the specific action of the specific person, and the attribute value of the specific action in response to the user's detailed query indication.

In addition, the method may further include starting recording the collected video and audio information in response to recognizing a specific person's specific action, and stopping recording in response to recognizing that the specific person's specific action ends, and recording the recorded The content is stored in association with the identified specific person, the particular person's specific action, the attribute value of the specific action, and in response to the user's detailed query indication, the specific action with the specific person, the specific person, the specific action attribute values show the video and audio links for that particular action.

In addition, in response to a user clicking a video and audio link, the output interface may output the recorded content stored in association with the specific person, the specific person of the specific person, and the attribute value of the specific person.

Optionally, in response to the captured video and audio information, identifying the content of the video and audio information may include identifying a particular person's particular activity from the captured video and audio information.

Optionally, the particular person may be identified based on one or more of face recognition, height recognition, voice recognition.

Optionally, the method may further include receiving a wireless signal sent by a portable phone, and the specific person is identified based on the identity of the portable phone indicated in the wireless signal.

Optionally, the specific action may be identified based on the captured video and audio information and the depth sensed by the depth sensor.

Optionally, the specific action may be to identify the match with the established model by modeling the model for the specific action in advance and searching the collected video and audio information for the model.

Optionally, the model may be generated by means of self-learning.

Optionally, the model may be a pre-input standardized model.

The flowchart and block diagrams in the figures illustrate the architecture, functionality, and operation of possible implementations of systems, methods, and computer program products according to various embodiments of the present invention. In this regard, each block of the flowchart illustrations or block diagrams, which may represent a module, a section of a program, or a portion of a code that includes one or more portions of a program for implementing specified logic functions Executable instructions. It should also be noted that in some alternative implementations, the functions noted in the blocks may occur out of the order noted in the figures. For example, two consecutive blocks may in fact be executed substantially in parallel, and sometimes they may be executed in the reverse order, depending on the function involved. It is also to be noted that each block of the block diagrams and/or flowchart illustrations, and combinations of blocks in the block diagrams and/or flowchart illustration, can be implemented by special purpose hardware-based systems that perform the specified functions or operations, or may be implemented by a combination of special purpose hardware and computer instructions.

It will be apparent to those skilled in the art that the present invention is not limited to the details of the foregoing exemplary embodiments, but that the invention may be embodied in other specific forms without departing from the spirit or essential characteristics of the invention. Therefore, no matter the point of view, the embodiments should be regarded as exemplary and not limitative. The scope of the invention is defined by the appended claims rather than by the foregoing description. It is therefore intended to include in the invention all the changes which come within the meaning and range of equivalency of the claims. Any reference signs in the claims should not be construed as limiting the claim involved.

1. A behavior pattern statistical apparatus comprises:
a video capture unit for collecting and transmitting video information in real time;
an audio capture unit for collecting and transmitting audio information in real time;
a processing device for identifying a specific person's specific action from the video and audio information collected by the video capture unit and the audio capture unit, and identifying an attribute value of the specific action in the collected video and audio information in response to identifying a specific action of a specific person;
a storage for storing a specific person recognized by the processing device, a specific action of the specific person, and an attribute value of the specific action in combination; and
an output interface for outputting statistical attribute values of a specific action of a specific person for a certain period of time,
wherein a statistical attribute value of a specific action of a specific person over a specific period of time is a statistic of the processing device for all of the specific actions of the specific person over a specific time period.

2. The behavior pattern statistical apparatus according to claim 1, further comprising: an input interface for receiving a user's detailed query indication of a specific action of a specific person for a specific time period, and
in response to the user's detailed query indication, the output interface displays all the specific actions of a specific person for a specific period of time, including a specific person, a specific action of the specific person, and an attribute value of the specific action.

3. The behavior pattern statistical apparatus according to claim 2, further comprising a recorder for initiating recording of the video and audio information captured by the video capture unit and the audio capture unit in response to identifying a specific action of a specific person and stops recording in response to recognizing that a specific person's specific action is ended, and stores the recorded content in a storage the identified specific person, the specific action of the specific person and the attribute value of the specific action in combination, and
in response to the user's detailed query indication, the output interface further displays the visual and audio links of the specific action in combination with the specific person, the specific action of the specific person, and the attribute value of the specific action.

4. The behavior pattern statistical apparatus according to claim 3, wherein in response to the user clicking a link for a video or an audio, the output interface outputs recorded content stored in the storage related to the specific person, the specific action of the specific person, and the attribute value of the specific action.

5. The behavior pattern statistical apparatus according to claim 1, wherein the processing device also compares the statistical attribute values of a specific action of a specific person for a certain period of time with respective thresholds, generates an evaluation based on the comparison result, and then output through the output interface.

6. The behavior pattern statistical apparatus according to claim 1, wherein the processing device further compares the statistical attribute value of the specific action of the specific person with the statistical attribute value of the specific action of the other person at the specific time period, and output through the output interface by paralleling.

7. The behavior pattern statistical apparatus according to claim 1, wherein the processing device further compares the statistical attribute value of the specific action of the specific person with the statistical attribute value of the specific action of the specific person at other previous time periods, and output through the output interface by paralleling.

8. (canceled)

9. The behavior pattern statistical apparatus according to claim 1, further comprising: an input interface for receiving at least one of a specified action of a specific person to be identified, a corresponding attribute, and a name of a corresponding statistical attribute.

10. (canceled)

11. The behavior pattern statistical apparatus according to claim 1, wherein the processing device further receives a wireless signal sent by a mobile phone and identifies a specific person based on the identity of the mobile phone indicated in the wireless signal.

12. The behavior pattern statistical apparatus according to claim 1, wherein the specific action is identified by previously setting a model for a specific action, and searching the video and audio information collected respectively from the video capture unit and the audio capture unit for an action matching the model.

13-14. (canceled)

15. The behavior pattern statistical apparatus according to claim 1, further comprising a depth sensor, and the identification of the specific action is based on the video and audio captured respectively by the video capture unit and the audio capture unit, and the depth sensed by the depth sensor.

16-17. (canceled)

18. A behavioral pattern statistical method comprising:
capturing video and audio information in real time;
recognizing a specific action of a specific person from the video and audio information;
identifying an attribute value of the specific action in the collected video and audio information, in response to recognizing a specific action of a specific person;
obtaining statistics of attribute values of all the specific actions of the specific person in a specific time period to obtain statistical attribute values of a specific action of a specific person in a specific time period; and
outputting the attribute value or statistical attribute value of a specific action of a specific person for a certain period of time.

19. The behavior pattern statistics method according to claim 18, further comprising:
storing the identified specific person, the specific action of the specific person, and the attribute value of the specific action in combination.

20. The behavior pattern statistics method according to claim 19, further comprising:
receiving a user's detailed query indication of a specific action of a specific person for a specific period of time;
in response to the user's detailed query indication, displaying all of the specific actions of a specific person for a certain period of time, including a specific person, a specific action of the specific person, and an attribute value of the specific action.

21. The behavior pattern statistics method according to claim 20, further comprising:
in response to identifying a specific person's specific action, recording the captured video and audio information and in response to recognizing that a specific person's specific action has ended, stopping the recording and storing the recorded content in combination with the identified specific person, the specific person's specific action, and attribute values of the specific action;
in response to the user's detailed query indication, the visual or audio links for the specific action are displayed in combination with the specific person, the specific person's specific action, and attribute values of the specific action.

22. The behavior pattern statistical method according to claim 21, wherein in response to the user clicking the visual or audio links, the output interface outputs the recorded content which is stored in combination with the specific person, the specific person's specific action, and attribute values of the specific action.

23. The behavior pattern statistical method according to claim 18, further comprising comparing a statistical attribute value of a specific action of a specific person for a certain period of time with a corresponding threshold, generating a rating based on the comparison result, and outputting the result.

24. The behavior pattern statistical method according to claim 18, further comprising: outputting the statistical attribute value of the specific action of the specific person for a certain period of time against the statistical attribute value of the specific action of other people at the specific time period.

25. The behavioral pattern statistical method according to claim 18, further comprising: outputting the statistical attribute value of the specific action of the specific person at a certain time period in comparison with the statistical attribute value of the specific action of the specific person at other previous time periods.

26-29. (canceled)

30. The behavior pattern statistical method according to claim 18, wherein the specific action is identified by creating a model for a specific action in advance and searching the acquired video and audio information for a match identified with the established model.

31-32. (canceled)
